(19) United States
(12) Patent Application Publication
(10) Pub. No.: US 2025/0113292 A1
(43) Pub. Date: Apr. 3, 2025

(54) Communication Mode Selection

(71) Applicant: Apple Inc., Cupertino, CA (US)

(72) Inventors: Ahmed M SOLIMAN, Munich (DE); Ayman F NAGUIB, Cupertino, CA (US); Danila ZAEV, Munich (DE); Kenza HAMIDOUCHE, Cupertino, CA (US)

(21) Appl. No.: 18/883,518

(22) Filed: Sep. 12, 2024

Related U.S. Application Data
(60) Provisional application No. 63/586,513, filed on Sep. 29, 2023.

(51) Int. Cl. H04W 48/18

(52) U.S. Cl. CPC H04W 48/18

(57) ABSTRACT

An apparatus configured to process, based on signaling received from a network, a message comprising an indication of one or more semantic communication modes supported by the network, execute an application, wherein the application supports one or more semantic communication modes also supported by a user equipment (UE), determine a first communication mode supported by the network and the application, wherein the first communication mode is a classic communication mode or a semantic communication mode and select the first communication mode to communicate with the network.

### PRIORITY/INCORPORATION BY REFERENCE

This application claims priority to U.S. Provisional Application Ser. No. 63/586,513 filed on Sep. 29, 2023, entitled “Communication Mode Selection,” the entirety of which is incorporated by reference herein.

### BACKGROUND

Wireless communication systems are rapidly growing in usage and constantly evolving. It is anticipated that future evolutions of the cellular standards (e.g., 3GPP standards) may include different communication modes. These different communication modes may include classic communication mode and semantic communication mode. Classic communication mode will be similar to the communication modes currently implemented with certain evolutions or improvements. Semantic communication involves a sender transmitting information about the transmission that allows a receiver to decode the communication regardless of whether the receiver has received each symbol or bit of the communication. There may be various levels of semantic communications. Selecting the correct communication mode is critical to achieve the best user experience. However, selecting the correct communication mode is not an easy task as it depends on different aspects.

### SUMMARY

Some example embodiments are related to an apparatus having processing circuitry configured to process, based on signaling received from a network, a message comprising an indication of one or more semantic communication modes supported by the network, execute an application, wherein the application supports one or more semantic communication modes also supported by a user equipment (UE), determine a first communication mode supported by the network and the application, wherein the first communication mode is a classic communication mode or a semantic communication mode and select the first communication mode to communicate with the network.

Other example embodiments are related to an apparatus having processing circuitry configured to execute an application, wherein the application supports a classic communication mode and a semantic communication mode, communicate with a first network using the classic communication mode, wherein the first network supports the classic communication mode with a first uplink (UL) data rate, determine a user equipment (UE) has left a coverage area of the first network and communicate with a second network using the semantic communication mode, wherein the second network supports the semantic communication mode with a second UL data rate that is lower than the first UL data rate.

Still further example embodiments are related to an apparatus having processing circuitry configured to process, based on signaling originated by a user equipment (UE), a request comprising the one or more semantic communication modes supported by an application being executed by the UE and the UE, generate, for transmission to the UE, a message comprising an indication of one or more semantic communication modes supported by a network and process, based on signals originated by the UE, a first communication mode selected by the UE, wherein the first communication mode is a classic communication mode or a semantic communication mode.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example arrangement of a user equipment (UE) executing an application that is configured to use multiple communication modes according to various example embodiments.

FIG. 5 shows an overview of inputs the UE may use to perform communication mode selection according to various example embodiments.

FIG. 6 shows a signaling diagram including an exchange of semantic communication capabilities between the UE and the network according to various example embodiments.

FIG. 7 shows an overview of a first UE communicating with a second UE according to various example embodiments.

FIG. 8 shows a signaling diagram for signaling the UE with a network preference related to semantic communications according to various example embodiments.

FIG. 9 shows an example scenario for the UE to select a communication mode based on channel conditions according to various example embodiments.

FIG. 10 shows an example method for the UE 110 to select a communication mode according to various example embodiments.

### DETAILED DESCRIPTION

The example embodiments may be further understood with reference to the following description and the related appended drawings, wherein like elements are provided with the same reference numerals. The example embodiments relate to selecting a communication mode for a user equipment (UE) wherein at least one of the available communication modes is a semantic communication mode.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a sixth generation (6G) network and corresponding base stations. However, reference to a 6G network and base station is merely provided for illustrative purposes. The example embodiments may be utilized with any appropriate type of network and base station that are capable of multiple communication modes, e.g., classic communication mode and multiple levels of semantic communications, including future evolutions of the cellular standards beyond 6G.

The example embodiments describe manners of selecting a communication mode for use with a UE executing an application. The communication modes may include classic communication mode and multiple levels of semantic communications. Semantic communication is typically lossy, and the result obtained by the recipient may not exactly match what was sent by the sender. However, due to power saving and other advantages, semantic communication mode may be an attractive option in some scenarios but not all. For example, not all applications tolerate non-exact transmission of the data. Thus, semantic communication may be appropriate for a specific set of applications but not all. The example embodiments provide allow a UE to select the appropriate communication mode based on various inputs that may be local to the UE (e.g., application capability, UE conditions such as battery level and thermal conditions), may be based on network capabilities and/or network conditions (e.g., congestion), channel conditions, the capabilities of UEs with which the UE is communicating, etc. Each of these inputs and the effect of the inputs on the selection will be described in greater detail below.

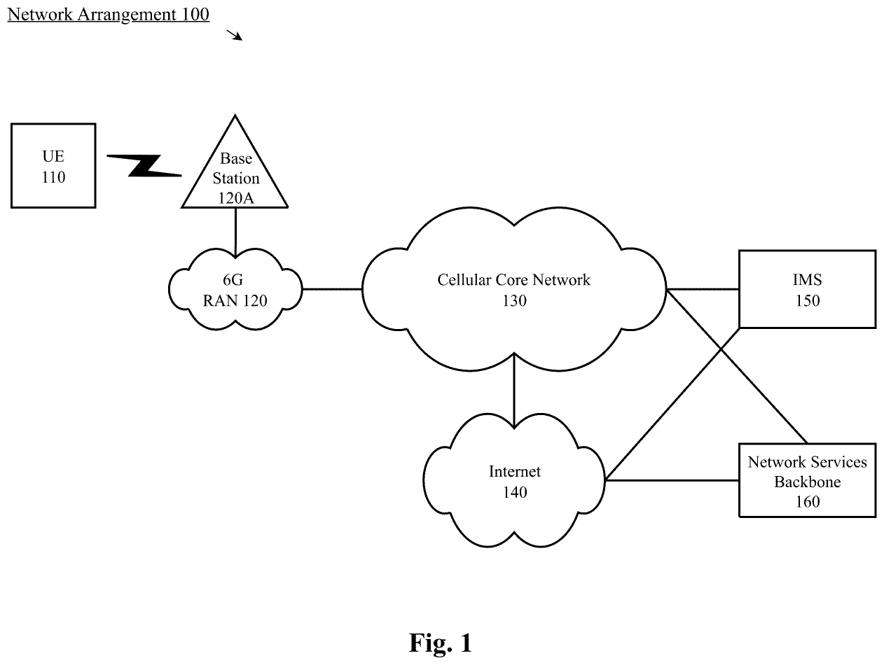

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 6G radio access network (RAN) 120. However, the UE 110 may also communicate with other types of networks (e.g., fifth generation (5G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 6G RAN 120. Therefore, the UE 110 may have at least a 6G chipset to communicate with the 6G RAN 120.

The 6G RAN 120 may be a portion of a cellular network that may be deployed by a network carrier (e.g., Verizon, AT&T, T-Mobile, etc.). The 6G RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 6G RAN 120. For example, as discussed above, the 6G RAN 120 may be associated with a particular cellular provider where the UE 110 and/or the user thereof has a contract and credential information (e.g., stored on a SIM card). Upon detecting the presence of the 6G RAN 120, the UE 110 may transmit the corresponding credential information to associate with the 6G RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC), the 5G core (5GC), the 6G core (6GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

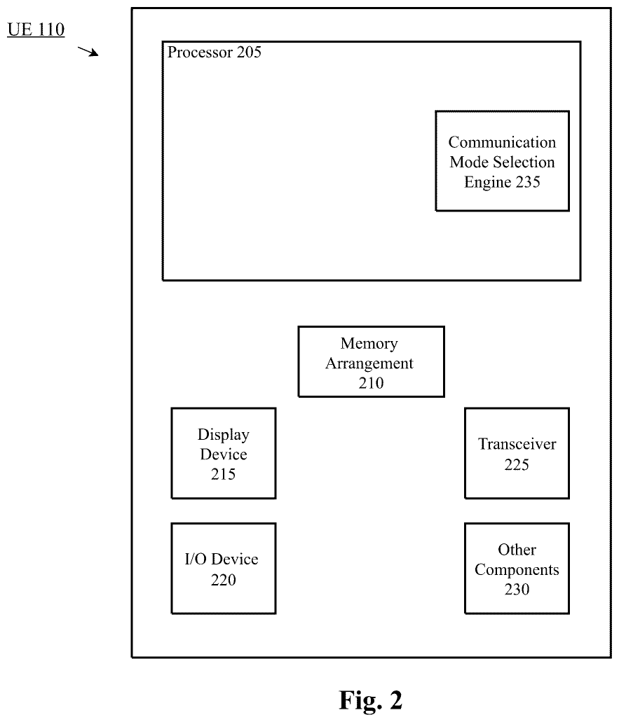

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a communication mode selection engine 235. The communication mode selection engine 235 may perform various operations related to selecting the communication mode to be used by the UE 110. To provide some general examples, the communication mode selection engine 235 may perform operations such as, but not limited to, informing a network about the communication mode capabilities of the UE 110, selecting a communication mode based on various inputs and negotiating with a further UE as to a communication mode for communicating between the UEs. Each of these example operations will be described in greater detail below.

The above referenced engine 235 being an application (e.g., a program) executed by the processor 205 are merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. In particular, in some examples, it is the capabilities of the UE 110 typically handled by the baseband processor that may be reduced when the UE 110 is operating in the low battery mode. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 6G-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

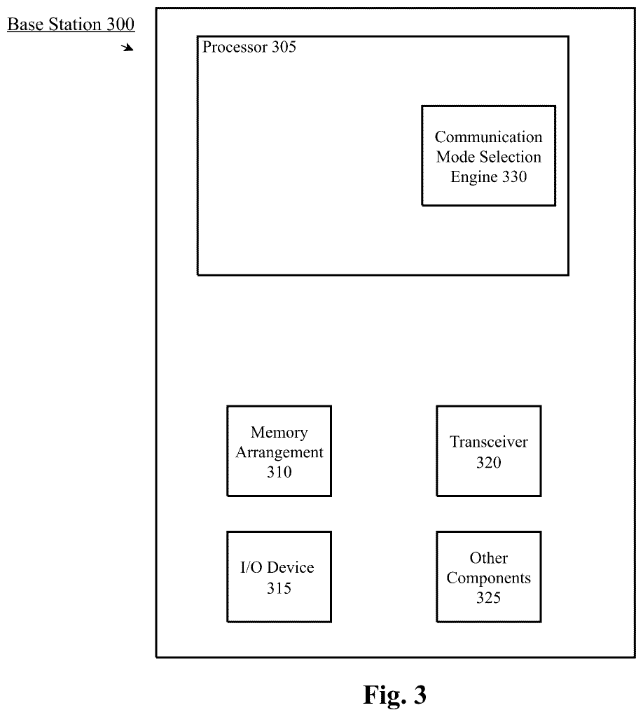

FIG. 3 shows an example base station 300 according to various example embodiments. The base station 300 may represent any base included within the network, e.g., base station 120A.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a communication mode selection engine 330. The communication mode selection engine 330 may perform various operations for the base station 300 related to providing UEs with information for the UEs to select a communication mode to communicate with the network. To provide some general examples, the communication mode selection engine 330 may perform operations such as, but not limited to, receiving capability information including communication modes supported by the UE, sending the network capability information including communication modes supported by the network and sending network preferences for communication mode selection by the UE. Each of these example operations will be described in greater detail below.

The above noted engine 330 being an application (e.g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some servers, the functionality described for the processor 305 is split among a plurality of processors (e.g., a baseband processor, an applications processor, etc.). In particular, in some examples, it is the operations for communicating with the UE 110 that are typically handled by the baseband processor that may be reduced when the UE 110 is operating in the low battery mode. The example embodiments may be implemented in any of these or other configurations of a server.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100.

The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

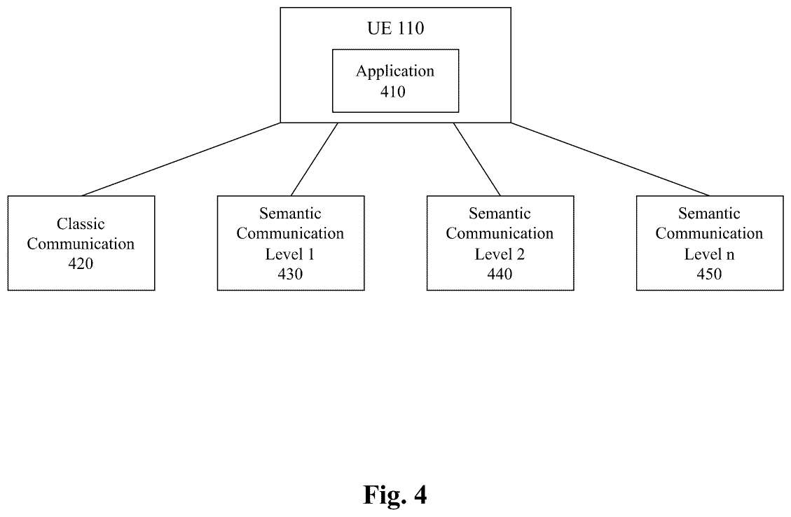

FIG. 4 shows an example arrangement of a user equipment (UE) 110 executing an application 410 that is configured to use multiple communication modes according to various example embodiments. Initially, the UE 110 may support multiple communication modes, e.g., the communication layers implemented by the UE 110 may support various communication modes. Thus, throughout this description, when it is described that an application executing on the UE 110 supports a communication mode, it should be considered that the communication layers of the UE 110 also support this communication mode.

Each application executed by the UE 110 may support one or more of these communication modes. For example, each application resident on the UE 110 may inform the UE 110 (e.g., the communication mode selection engine 235) of the different communication modes supported by the application. In this example, it may be considered that the UE 110 and application 410 support communication modes 420-450. These modes include classic communication mode 420, semantic communication mode level 1 430, semantic communication mode level 2 440 and semantic communication mode level n 450. Throughout this description, whether stated in an example or not, the UE 110 will always support the classic communication mode.

As of today, there are no specific definitions of the different levels of semantic communications. The following provides some examples of how semantic communication levels may be defined. However, these are only examples and the example embodiments may be applied to any scenario where different levels of semantic communication are defined regardless of the specific definition of each level. For example, in semantic video transmission, the semantic levels may correspond to different number of semantic key points representing a frame together with a different reconstruction model, e.g., a more simple and less deep neural network (NN) model may reconstruct the image based on a large number of points, while a deep and more complex NN model may reconstruct the image based on a smaller number of points. In this example, the increase of semantic level may lead to a loss of the details.

In another example, in the case of video, a semantic level may be defined based on the aggressiveness of the compression at the application layer. Aggressive compression would lead to more lost information but compact or small-size messages to be transmitted and low usage of network resources. Again, these are only examples of how semantic communication mode levels may be defined.

In a still further example, different semantic communication mode levels may be defined based on the characteristics of the semantic communication. For example, one semantic communication mode level may include retransmissions while another semantic communication mode level may be without retransmissions.

As described above, the example embodiments are related to the UE 110 selecting the communication mode (e.g., communication modes 420-450) when executing the application 410.

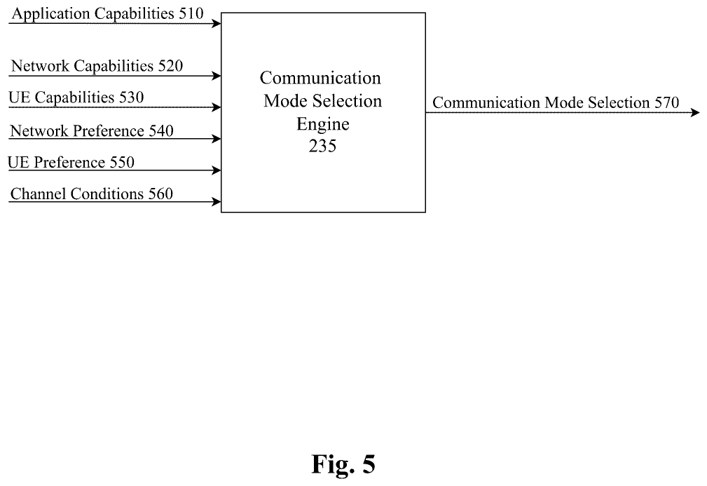

FIG. 5 shows an overview of inputs the UE 110 may use to perform communication mode selection according to various example embodiments. In this example, it is considered that the communication mode selection engine 235 being executed by the UE 110 is determining the communication mode selection 570 for the UE 110.

The example inputs to the communication mode selection engine 235 include application capabilities 510, network capabilities 520, UE capabilities 530, network preferences 540, UE preferences 550 and channel conditions 560. These inputs are only examples and other inputs may be used separately or in conjunction with the listed example inputs. In addition, there is no requirement that each of the example inputs be used to make the communication mode selection 570, e.g., the communication mode selection 570 may be performed using each example input separately or in any combination. In addition, each example input may be weighted to have a weighted impact on the communication mode selection 570.

The application capabilities 510 and the UE capabilities 530 were described above. Each of the additional example inputs will be described in greater detail below.

When the example inputs are described, for some inputs like channel conditions 560, UE preferences 550 (such as battery level and thermal conditions), etc., the communication mode selection engine 235 may use a current status and predicted inputs. Providing predicted inputs to the communication mode selection engine 235 may help to provide the decision of communication mode selection 570 at the correct time.

In some example embodiments, the UE 110 may use a timer to prevent multiple switches in a short period of time, e.g., ping-ponging. For example, in a very dynamic environment (e.g., at a cell edge), many switches between different communication modes may negatively impact user experience. The timer may be used to maintain a minimum period before switching the communication mode.

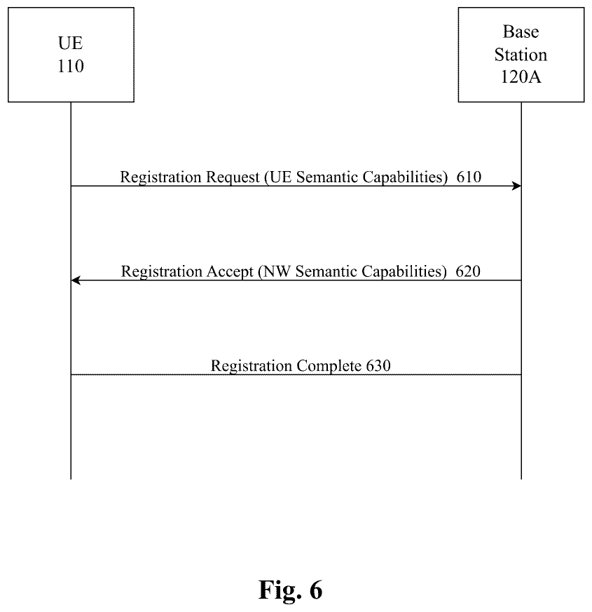

FIG. 6 shows a signaling diagram 600 including an exchange of semantic communication capabilities between the UE 110 and the network according to various example embodiments. The signaling diagram 600 is performed between the UE 110 and the network (e.g., base station 120A). As described above, the UE 110 may consider the network capabilities 530 when selecting the communication mode. In addition, as will be described in greater detail below, the network may also use the semantic communication capabilities of the UE 110 in the example embodiments. The signaling diagram 600 provides one example of the UE 110 and the network exchanging semantic communication capabilities during a registration process, which may be an initial registration process or a mobility registration process. The semantic communication capabilities may also be exchanged during other signaling processes performed between the UE 110 and the network.

In this example, the UE 110 transmits a registration request 610 to the base station 120A. The registration request may include various information in the form of, for example, information elements (IEs) or other manners of conveying information. In this example, the registration request includes the UE capabilities 530 related to semantic communications, e.g., the UE 110 supports semantic communication levels 430-450.

The base station 120A may respond with a registration accept 620 that includes the network capabilities 520 related to semantic communications, e.g., the semantic communication levels supported by the network. In some example embodiments, the network may support many or all semantic communication levels. However, this does not mean the network will report all the semantic communication levels in the network capabilities 520. For example, the network may report the supported semantic communication levels in the network capabilities 520 based on a subscription of the UE 110 (or user of the UE 110), e.g., the subscription may entitle the user of the UE 110 to a specified subset of the semantic communication levels supported by the network.

In 630, the UE 110 may respond with a registration complete message indicating the registration is complete. A registration process may include additional messages exchanged between the UE 110 and the network and the signaling diagram 600 is only providing an overview related to the exchange of semantic communication capabilities. Thus, at the completion of signaling diagram 600, both the UE 110 and the network will understand the network capabilities 520 and the UE capabilities 530 with respect to semantic communications.

In some example embodiments, the network may broadcast the support of semantic communication modes on a per cell basis, e.g., an IE in a system information block (SIB) may include the network capabilities 520 with respect to semantic communications of the individual cell. In these example embodiments, the network may not have to include the network capabilities 520 in the registration accept 620. In some example embodiments, both a SIB and the registration accept message may be used to transmit the network capabilities 520. For example, the registration accept message may include the semantic capabilities of the core network while the broadcasted SIB may include the semantic capabilities of the radio access network (RAN) (e.g., the capabilities of the specific cell).

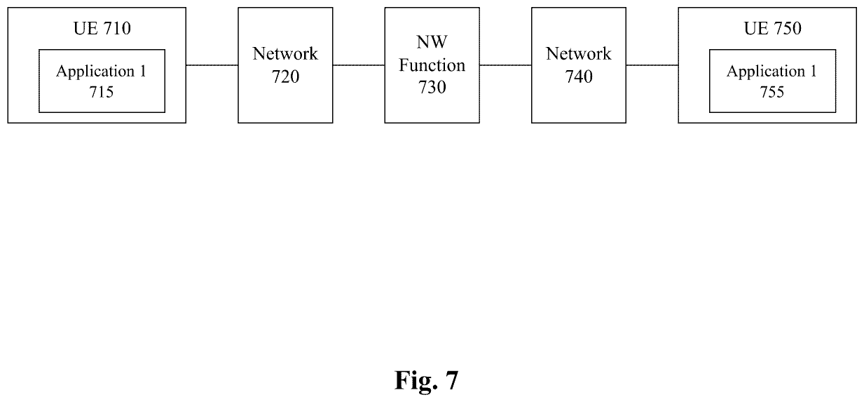

FIG. 7 shows an overview of a first UE 710 communicating with a second UE 750 according to various example embodiments. In this example, it may be considered that the UE 710 is executing an application 1 715 and the UE 750 is executing a corresponding application 1 755, e.g., a video call application or any application where the UEs 710 and 750 are exchanging data. When the UEs 710 and 750 are capable of selecting semantic communication mode, the selected semantic communication level should be aligned between the source (e.g., the UE 710) and the destination (e.g., the UE 750) to be able to complete the end to end communication. Thus, the source and destination UEs may share the supported capabilities and may use this information to select the best common communication mode. While the destination in the example of FIG. 7 is another UE, there is no requirement that the destination be another UE. For example, the destination may be a server or other device capable of semantic communication.

In the example of FIG. 7, it is considered that the UE 710 is connected to the network 720 and the UE 750 is connected to the network 740. The network 720 and the network 740 may be the same network or may be different networks. In addition, each of the networks 720 and 740 may have access to a network function 730 (e.g., an application function (AF) that is, for example, implemented in the core network 130). In other example the network function 730 may be a third party server, such as a server that handles video call.

To provide an example, it may be considered that the application 1 715 executed by the UE 710 (and the network 720) may support the semantic communication mode level 1 430, semantic communication mode level 2 440 and semantic communication mode level n 450. This information may be reported to the application 1 755 executed by the UE 750. Further, it may also be considered that the application 1 755 executed by the UE 750 (and the network 740) may support the semantic communication mode level 1 430 and semantic communication mode level 2 440 but not semantic communication mode level n 450. This information may be reported to the application 1 715 executed by the UE 710. Thus, the common supported semantic communication levels for the UE 710 and 750 are semantic communication mode level 1 430 and semantic communication mode level 2 440. The UEs 710 and 750 may use this information to then select the “best” one of the commonly supported semantic communication modes. Example manners of selecting the “best” one of the commonly supported semantic communication modes are described in greater detail below.

In the example described above, it was considered that the UEs 710 and 750 exchanged the supported semantic communication levels. As described above, the UEs may provide their semantic communication capabilities to the network in the registration request 610. These semantic communication capabilities may be stored in the network function 730. Thus, in some examples, the exchange of the semantic communication capabilities of the UEs 710 and 750 may be facilitated using the network function 730.

In addition, if the list of supported semantic communication levels for either of the UEs 710 or 750 changes, e.g., because of mobility, the network function may facilitate a new exchange of semantic capabilities between the UEs 710 and 750 to be used to negotiate a new commonly supported semantic communication mode. Mobility will typically not change the semantic communication capabilities of the UE but may change the semantic communication capabilities of the network to which the UE is connected.

In the above example, it was considered that the communication was between two UEs 710 and 750. However, there may be applications that allow more than 2 UEs to participate, e.g., a group video call. In some example embodiments, the same principles may be applied for group communications, e.g., the “best” commonly supported semantic communication modes among all the UEs participating in the communication may be selected.

In other example embodiments, different semantic communication modes may be selected. For example, consider a scenario where there are five UEs in a group communication. Three of the UEs support commonly supported semantic communication mode levels 430-450 and the remaining two UEs only support the semantic communication mode level n 450. If it were considered that semantic communication mode level 1 430 was the “best” communication mode, the first three UEs may select semantic communication mode level 1 430 and the remaining two UEs may select the semantic communication mode level n 450. In this example, it may be considered that communication may be performed between the semantic communication mode level 1 430 and the semantic communication mode level n 450, e.g., the semantic communication mode level 1 430 provides more information which could be simply ignored by the semantic communication mode level n 450.

As described above, another example input for the selection of the communication mode may include a network preference 540. The following provides some examples of network preferences 540 but these are only examples and other types of network preferences may also be provided by the network to the UE 110.

In some networks, unified access control is defined to enable the network to allow/prevent specific access. For example, in congestion scenarios, the network may prevent mobile data by marking mobile originating data as barred in the broadcast information. In the example embodiments, in congestion scenarios, instead of preventing the UE 110 from sending any traffic, the network may allow data transmissions but limit it to defined semantic communication levels to reduce the load on network resources with minimum impact on user.

These network preferences 540 may be signaled to the UE 110 in various manners. In some example embodiments, a new access category for “semantic data” may be defined to allow the network to bar or allow “semantic data” independent of other traffic.

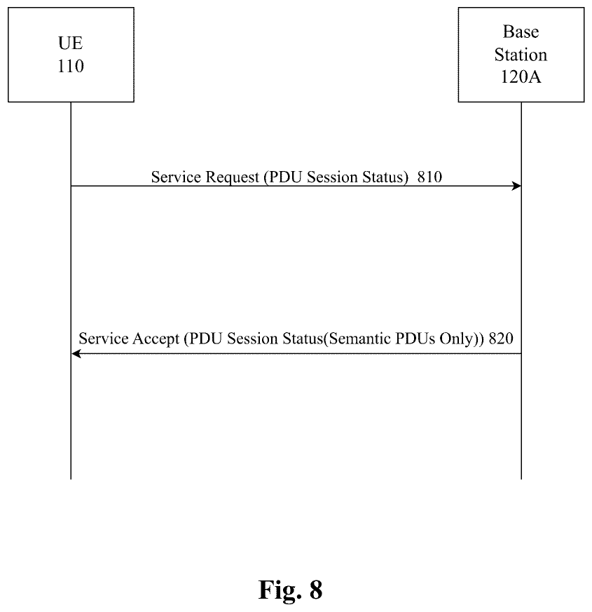

In other examples, the network preference 540 may be signaled during protocol data unit (PDU) session requests by the UE 110. FIG. 8 shows a signaling diagram 800 for signaling the UE with a network preference related to semantic communications according to various example embodiments. The signaling diagram 800 is performed between the UE 110 and the network (e.g., base station 120A, an Access and Mobility Management Function (AMF) of the network, etc.).

In 810, the UE 110 transmits a service request to establish radio resources for PDUs (semantic and non-semantic PDUs) to the network. As described above, the network may be experiencing a congestion scenario where the network wants to limit any data transmissions by the UE 110 to semantic communications. Thus, in the service accept 820, the base station 120A indicates that the acceptance is limited to PDU sessions related to semantic communications. In some example embodiments, this may be valid when a specific PDU session is established for semantic traffic only.

In other scenarios, the network preference 540 may be a recommendation to use a specific communication mode but it is not required. For example, when the network is in a high load scenario but not yet in a congestion scenario, the network may inform the UE 110 that it is recommended to use one or more of the semantic communication mode levels. The UE 110 may then use this network preference 540 when performing the communication mode selection 570. As described above, the network preference may be weighted accordingly to influence the communication mode selection 570.

In some example embodiments, the network may inform the UE 110 that the provided network preference 540 should be applied immediately. In other example embodiments, the network may inform the UE 110 that the provided network preference 540 should be applied during a specific time window based on the network prediction system. For example, the network may predict high load at specific period. During this period, the network may request the UE 110 to switch to one or more of the semantic communication levels 430-450 and revert back to the classic communication mode 420 when the period has expired.

As described above, another example input for the selection of the communication mode may include a UE preference 550. The following provides some examples of UE preferences 550 but these are only examples and other types of UE preferences may also be considered by the UE 110 when performing the communication mode selection 570. In the example embodiments, the UE preferences 550 may be based on input of other components of the UE 110 including, but not limited to, battery inputs, sensor inputs such as thermal sensors, etc.

In some example embodiments, the UE preference 550 may be based on battery level. For example, the UE 110 may want to limit the power consumption used for data transmissions when a battery level drops below a predetermined threshold. This may be done by limiting the amount of data to be transmitted. For example, semantic communication mode may save power as compared to classic communication mode because there is typically less data transmitted in semantic communication mode. The different levels of semantic communication mode may correspond to different battery levels at or below the threshold, e.g., as the battery level decreases, semantic communication mode levels using less data may be selected. In some example embodiments, a machine learning (ML) model may be trained to learn the correlation between semantic communication mode levels and the corresponding power saving from data reduction. The UE 110 may then implement this ML model to select the appropriate semantic communication mode level based on battery levels.

In other example embodiments, the UE preference 550 may be based on thermal conditions of the UE 110. For example, when device temperature reaches a predetermined threshold, data throttling may be used to reduce the data to be transmitted to reduce the device temperature. Again, when data throttling is indicated, semantic communication mode may be used instead of classic communication mode to achieve data throttling but with a lower impact on user experience. Again, similar to the example of battery level described above, the specific semantic communication mode level(s) that are used may be based on the specific temperature of the device and the device may implement an ML model to learn the thermal reduction related to different semantic communication mode levels.

In still further example embodiments, the UE preference 550 may be based on cost reduction of the UE 110. For example, a user of the UE 110 may have to pay for the amount of data that is used by the UE 110 and therefore there is an incentive to reduce the amount of data used by the UE 110. However, the user does not want to reduce the data usage to a point where user experience is affected.

To provide some examples of cost related UE preferences 550, the UE 110 may be in a roaming scenarios. In a roaming scenarios, the user may prefer to reduce the usage of mobile data to avoid additional charges, therefore semantic communication mode may be used to keep user connected with minimum charges. For example, the user may be able to select between enabling mobile data during roaming scenarios, disabling mobile data during roaming scenarios and/or enabling semantic mobile data (or reduced data mode) only during roaming scenarios.

In another example, the user may have a subscription that limits the amount of data based on a period and thereafter the data is charged at a higher rate, e.g., a monthly data limit. As the UE 110 approaches this data limit, e.g., within a predetermined threshold of the data limit, the UE preference 550 may be to reduce data usage to keep the UE 110 connected with normal charges. Therefore, when this scenario occurs, e.g., within the predetermined threshold of the data limit, the UE 110 may prefer semantic communication mode to reduce data usage. Again, similar to the examples of battery level and thermal levels described above, the specific semantic communication mode level(s) that are used may be based on the amount of data left before the UE 110 reaches the data limit and the UE 110 may implement an ML model to learn the data usage reductions related to different semantic communication mode levels.

In the above examples, the UE preferences 550 (e.g., based on battery level, thermal level, cost reduction) resulted in selection of a communication mode based on reducing data throughput. However, there may be UE preferences 550 that are used to select different communication modes based on different aspects other than data reduction. For example, there may be a UE preference 550 related to latency where a semantic communication mode without retransmission may reduce the end to end latency which is a critical requirement for some applications. Thus, in this type of example, a semantic communication mode level that comprises semantic communication without retransmission may be selected.

In another example, there may be a UE preference 550 related to privacy. For example, some communication modes may be better at preserving user privacy. Consider an example of a semantic conference call where a sender may share the same semantic data with all destinations but the reconstructed output may be different based on side information shared with each destination, e.g., the face of the sender will be displayed to one destination, while an emoji is displayed to another destination.

In a still further example, there may be a UE preference 550 related to quality. Sending equivalent data may not be accepted in all cases. For example, in some applications the exact information should be transmitted and received, i.e., semantic communication may not be supported by all applications, which is the reason that each application may provide its capabilities to the communication mode selection engine 235.

As described above, another example input for the selection of the communication mode may include channel conditions 560. The following provides some examples of channel conditions 560 but these are only examples and other types of channel conditions may also be considered by the UE 110 when performing the communication mode selection 570.

For example, when the UE 110 is experiencing bad coverage conditions, the required data rates for classic communication mode may not be achievable. In such scenarios, to keep a good user experience, the UE 110 may switch to a data reduction mode (e.g., semantic communication mode) to enable the high quality service even in the bad coverage conditions. When the UE 110 moves back to good coverage, the UE 110 may revert back to classic communication mode.

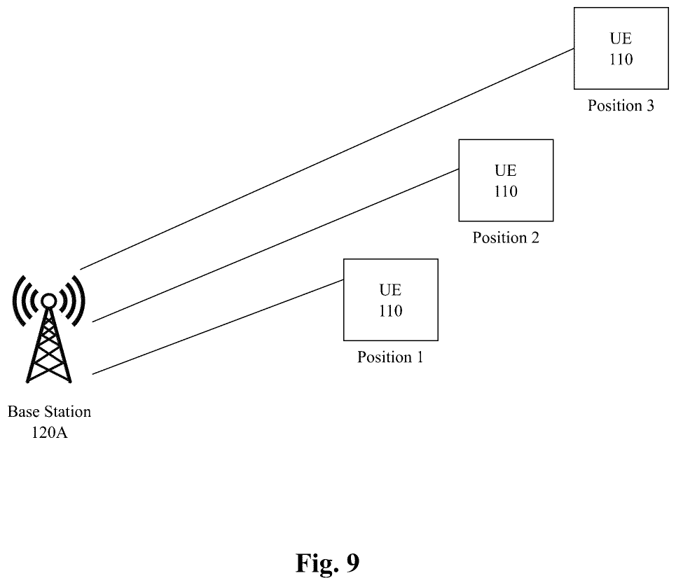

FIG. 9 shows an example scenario for the UE 110 to select a communication mode based on channel conditions according to various example embodiments. In the example of FIG. 9, the UE 110 is shown at various locations in relation to the base station 120A, e.g., position 1, position 2 and position 3. It may be considered that the closer the UE 110 is to the base station 120A, the better the channel conditions.

Thus, for example, when the UE 110 is located near to base station (e.g., position 1), the UE 110 may use classic communication mode 420. When the UE 110 moves to position 2 and faces worse coverage than at position 1, the UE 110 may switch to semantic communication mode level 1 430. When the UE 110 moves to position 3 and faces worse coverage than at position 1 or position 2, the UE 110 may switch to semantic communication mode level 440 that has a greater data reduction than semantic communication mode level 1 430. When the UE 110 returns back to position 1 the UE 110 may revert to classic communication mode 420.

There may also be other considerations used by the UE 110 in selecting a communication mode. For example, the network may provide a dedicated slice for semantic communication. In this case, selection of the communication mode may depend on the availability of this slice, e.g., by checking the allowed Network Slice Selection Assistance Information (NSSAI) and the User Equipment Route Selection Policy (URSP) provided by the network.

As described above, when multiple semantic communication mode levels are commonly supported by a sender and a receiver, a “best” semantic communication mode level may be selected. In the above examples, some examples of selecting between different semantic communication mode levels were described, e.g., selecting with or without retransmissions, selecting based on a level of data reduction for a specified battery level, etc. The following provides additional manners of selecting between different semantic communication mode levels.

Some semantic communication modes may allow a distortion (at bit level or at packet level) in communication system and use the distorted data at the application. Semantic distortion of the data monotonically depends on the physical level distortion, but the exact dependency may be different for different modes, applications and categories of data. If semantic distortion is small, the result may be acceptable by the application. If semantic distortion is high, the result may be unacceptable by the application.

Physical distortion may be measured, e.g., in terms of signal-to-noise ratio (SNR) after all physical layer (PHY) procedures for real-valued data, or in terms of bit error rate (BER) after decoding for bit sequences. In both cases, it may be estimated based on existing pilot-based procedures, e.g., demodulation reference signals (DMRS), channel state indication reference signals (CSI-RS), etc.

An application may know the relationship between physical distortion and semantic distortion for each particular semantic communication mode level. For example, an application, may be able to estimate a physical distortion threshold based on a semantic distortion threshold.

Thus, in some example embodiments, an application (e.g., the application 410 of FIG. 4) may specify the physical distortion threshold for each semantic communication mode level. This information may be reported to the communication mode selection engine 235 of the UE 110 and may also be provided to the network as a part of UE capability information, e.g., as reported in the example of FIG. 6. The reliability of this requirement may also be specified and the semantic capabilities are assumed to be supported by the application only if the corresponding requirements are satisfied.

To provide a specific example, it may be considered that the application 410 of FIG. 4 reports the following physical distortion thresholds. For semantic communication mode level 1 430, SNR of 20 db, with a reliability=10⁻³ and for semantic communication mode level 2 440, BER of 10⁻², with a reliability=10⁻⁴. Thus, in this example, the semantic communication mode level 1 430 may be selected only if the network can provide at least 20 dB of SNR after PHY with 10⁻³ reliability. Similarly, semantic communication mode level 2 440 may be selected only if the network can provide BER 10⁻² after PHY and decoding with 10⁻⁴ reliability.

In another example of selecting between different semantic communication mode levels, specific applications may have a target goal and the data generation mechanism and transmission policies may be tailored to enable the destination to perform its task successfully, e.g., successfully decode the communication. The sampling and transmission policies depend on network conditions and the value of the information that is generated for the target task. For example, the sampling and transmission may be performed to prioritize the most valuable data samples for the destination. The semantic metric may depend on how well the task is performed in the case of machine type communications or on a perception semantic metric in the case of human type communications.

Thus, in some example embodiments, an application (e.g., the application 410 of FIG. 4) may specify its goal or target objective and the requirement for achieving that goal. For example, in case the task is time-constrained or critical, such information can be shared with the network. This information may be reported to the communication mode selection engine 235 of the UE 110 and may also be provided to the network as a part of UE capability information, e.g., as reported in the example of FIG. 6.

To provide a specific example, it may be considered that the application 410 of FIG. 4 reports that data samples about the environment can be generated every 2, 4, and 6 seconds, depending on the environment dynamics and the relevance of the generated sample for the target task. In the case of this target or goal, the semantic communication mode level may be selected based on a retransmission mechanism. For example, semantic communication mode level 1 430 may be selected when transmission fails and the information in the failed transmission is outdated or not relevant anymore, and no retransmission is requested. Rather, a new sample is generated at second 4, and is transmitted in a newly generated packet. On the other hand, semantic communication mode level 2 440 may be selected when transmission fails and as long as the information is still valuable, then retransmission can be requested.

In the above examples, it was considered that the network was a terrestrial network (TN). However, the example embodiments may also be used in multi-tier systems. For example, the multi-tier system may include a TN and a non-terrestrial network (NTN) such as a satellite network. For example, when the UE 110 is out of the coverage area of the TN, the UE 110 may connect to the NTN. However, the NTN may provide limited services that do not satisfy the user needs, e.g., the NTN does not support data throughput rates for classic communication mode for the application that the UE 110 is executing. Thus, to enable the UE 110 to obtain high quality services in such case of limited throughput of the NTN, the UE may switch to one of semantic communication mode levels based on the available data rates.

Thus, in these example embodiments of a multi-tier system, the communication mode selection engine 235 may consider a switch from one tier to another (e.g., TN to NTN or vice versa) when making the communication mode selection 570.

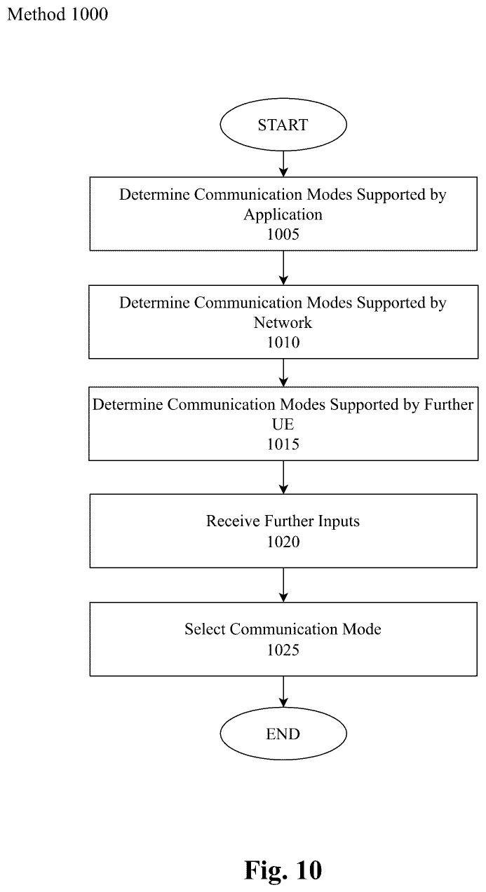

FIG. 10 shows an example method 1000 for the UE 110 to select a communication mode according to various example embodiments. The method 1000 is described from the standpoint of the communication mode selection engine 235 being executed by the processor 205 of the UE 110. Prior to the start of the method 1000, it may be considered that the communication mode selection engine 235 has knowledge of the UE capabilities 530, e.g., the semantic communication modes supported by the communication layers of the UE 110. In addition, as described above, it may be considered that each of the devices/components/networks/applications described herein support classic communication mode.

In 1005, the communication mode selection engine 235 receives the application capabilities 510, e.g., the semantic communication modes supported by the application. As described above, each application of the UE 110 may report its capabilities with respect to semantic communication to the communication mode selection engine 235.

In 1010, the communication mode selection engine 235 receives the network capabilities 520, e.g., the semantic communication modes supported by the network to which the UE is connected. As described above, the communication mode selection engine 235 may receive this information, for example, during a registration procedure (e.g., initial or mobility), as broadcast information, etc.

In 1015, the communication mode selection engine 235 may receive the semantic communication modes supported by a further UE (or other component) with which the UE is communicating via the application. As described above, in some scenarios the further UE is a single UE and in other scenarios the further UE may be multiple UEs. The communication mode selection engine 235 may use the capability information gathered in 1005-1015 to determine the common communication modes that are supported by each of the devices/components/networks/applications in the communication chain to ensure end-to-end communication consistency.

In 1020, the communication mode selection engine 235 may receive further inputs related to the selection of a communication mode. Some examples of these further inputs described as network preferences 540, UE preferences 550 and channel conditions 560 were described above. However, as stated above, other inputs may be used in addition to or exclusive of the described example inputs.

In 1025, the communication mode selection engine 235 uses the information gathered from 1005-1020 to select a communication mode for the UE 110. As also described above, this selected communication mode may include the classic communication mode or one or more semantic communication modes, examples of which were described above.

### Examples

In a first example, a method, comprising processing, based on signaling received from a network, a message comprising an indication of one or more semantic communication modes supported by the network, executing an application, wherein the application supports one or more semantic communication modes also supported by a user equipment (UE), determining a first communication mode supported by the network and the application, wherein the first communication mode is a classic communication mode or a semantic communication mode and selecting the first communication mode to communicate with the network.

In a second example, the method of the first example, further comprising processing, based on signaling originated by a further UE executing a corresponding application to the application, an indication comprising one or more semantic communication modes supported by the further UE, determining the first communication mode is supported by the network, the application and the further UE and communicating with the further UE using the first communication mode.

In a third example, the method of the second example, wherein the further UE comprises a plurality of UEs and the first communication mode is supported by all of the plurality of UEs.

In a fourth example, the method of the second example, wherein the UE, the application and the network further support a second communication mode, wherein the further UE comprises a plurality of UEs, a first subset of the plurality of UEs supporting the first and second communication mode and a second subset of the plurality of UEs supporting only the second communication mode, wherein the UE communicates with the first subset using the first communication mode and communicates with the second subset using the second communication mode.

In a fifth example, the method of the first example, wherein the message is received as part of a registration procedure performed by the UE with the network, wherein the registration procedure is an initial registration procedure or a mobility registration procedure.

In a sixth example, the method of the first example, wherein the message is received in a broadcast message from the network.

In a seventh example, the method of the first example, further comprising generating, for transmission to the network, a registration request comprising the one or more semantic communication modes supported by the application and the UE, wherein the registration request is for an initial registration procedure or a mobility registration procedure.

In an eighth example, the method of the first example, wherein the first communication mode comprises a first plurality of communication modes and the method further comprises selecting one of the first plurality of communication modes as the first communication mode based on a further input.

In a ninth example, the method of the eighth example, wherein the further input comprises an indication by the network that only semantic communication modes are to be used, wherein the first communication mode is a semantic communication mode.

In a tenth example, the method of the ninth example, wherein the indication comprises an access category.

In an eleventh example, the method of the ninth example, wherein the indication is received in a protocol data unit (PDU) service accept message from the network.

In a twelfth example, the method of the eighth example, wherein the further input comprises an indication by the network that semantic communication modes are preferred.

In a thirteenth example, the method of the twelfth example, wherein the indication further comprises a time in which the further input is to be applied, wherein the time comprises upon receipt of the indication or during a specified time window.

In a fourteenth example, the method of the eighth example, wherein the further input comprises a battery level of the UE.

In a fifteenth example, the method of the eighth example, wherein the further input comprises a temperature of the UE.

In a sixteenth example, the method of the eighth example, wherein the further input comprises an indication the UE is in a data roaming scenario.

In a seventeenth example, the method of the eighth example, wherein the further input comprises a data usage limit of a subscription of the UE.

In an eighteenth example, the method of the eighth example, wherein the further input comprises a latency requirement of the application.

In a nineteenth example, the method of the eighth example, wherein the further input comprises a privacy level of the application.

In a twentieth example, the method of the eighth example, wherein the further input comprises a quality requirement of the UE.

In a twenty first example, the method of the eighth example, wherein the further input comprises a channel condition of a connection between the UE and the network.

In a twenty second example, the method of the eighth example, wherein the first plurality of communication modes comprises two or more semantic communication modes and the further input comprises a physical distortion threshold of the application for each of the two or more semantic communication modes, wherein each of the two or more semantic communication modes are available for selection only if the network satisfies the physical distortion threshold for the respective two or more semantic communication modes.

In a twenty third example, the method of the twenty second example, wherein the physical distortion threshold comprises a signal-to-noise ratio (SNR) and corresponding reliability or bit error rate (BER) and corresponding reliability.

In a twenty fourth example, the method of the eighth example, wherein the further input comprises an indication of whether a network slice dedicated to semantic communication is available.

In a twenty fifth example, the method of the eighth example, wherein the further input comprises a parameter related to the UE, wherein the parameter comprises a current value of the parameter or a predicted value of the parameter.

In a twenty sixth example, the method of the first example, wherein the classic communication mode uses a higher data rate than the semantic communication mode.

In a twenty seventh example, the method of the twenty sixth example, wherein the semantic communication mode comprises a plurality of semantic communication modes and wherein each of the plurality of semantic communication modes uses a different data rate.

In a twenty eighth example, the method of the first example, further comprising starting a timer having a predetermined expiration time when the first communication mode is selected, wherein the UE is prevented from switching from the first communication mode until the timer has expired.

In a twenty ninth example, a user equipment (UE) configured to perform any of the methods of the first through twenty eighth examples.

In a thirtieth example, a processor configured to perform any of the methods of the first through twenty eighth examples.

In a thirty first example, a method, comprising executing an application, wherein the application supports a classic communication mode and a semantic communication mode, communicating with a first network using the classic communication mode, wherein the first network supports the classic communication mode with a first uplink (UL) data rate, determining a user equipment (UE) has left a coverage area of the first network and communicating with a second network using the semantic communication mode, wherein the second network supports the semantic communication mode with a second UL data rate that is lower than the first UL data rate.

In a thirty second example, the method of the thirty first example, wherein the first network is a terrestrial network and the second network is a non-terrestrial network.

In a thirty third example, a user equipment (UE) configured to perform any of the methods of the thirty first through thirty second examples.

In a thirty fourth example, a processor configured to perform any of the methods of the thirty first through thirty second examples.

In a thirty fifth example, a method, comprising processing, based on signaling originated by a user equipment (UE), a request comprising the one or more semantic communication modes supported by an application being executed by the UE and the UE, generating, for transmission to the UE, a message comprising an indication of one or more semantic communication modes supported by a network and processing, based on signals originated by the UE, a first communication mode selected by the UE, wherein the first communication mode is a classic communication mode or a semantic communication mode.

In a thirty sixth example, the method of the thirty fifth example, wherein the request is a registration request, wherein the registration request is an initial registration request or a mobility registration request.

In a thirty seventh example, the method of the thirty fifth example, wherein the message is transmitted in a broadcast message.

In a thirty eighth example, the method of the thirty seventh example, wherein the broadcast message comprises a system information block (SIB) transmitted by a cell of the network.

In a thirty ninth example, the method of the thirty fifth example, further comprising generating, for transmission to the UE, an indication that only semantic communication modes are to be used by the UE, wherein the first communication mode is a semantic communication mode.

In a fortieth example, the method of the thirty ninth example, wherein the indication comprises an access category.

In a forty first example, the method of the thirty ninth example, wherein the indication is transmitted in a protocol data unit (PDU) service accept message from the network.

In a forty second example, the method of the thirty fifth example, further comprising generating, for transmission to the UE, an indication that semantic communication modes are preferred by the network.

In a forty third example, the method of the forty second example, wherein the indication further comprises a time in which the further input is to be applied, wherein the time comprises upon receipt of the indication or during a specified time window.

In a forty fourth example, the method of the thirty fifth example, wherein the classic communication mode uses a higher data rate than the semantic communication mode.

In a forty fifth example, the method of the thirty fifth example, wherein the semantic communication mode comprises a plurality of semantic communication modes and wherein each of the plurality of semantic communication modes uses a different data rate.

In a forty sixth example, a network node configured to perform any of the methods of the thirty fifth through forty fifth examples.

In a forty seventh example, a processor configured to perform any of the methods of the thirty fifth through forty fifth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to deliver targeted content that may be of greater interest to the user in accordance with their preferences. Accordingly, use of such personal information data enables users to have greater control of the delivered content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
process, based on signaling received from a network, a message comprising an indication of one or more semantic communication modes supported by the network;
execute an application, wherein the application supports one or more semantic communication modes also supported by a user equipment (UE);
determine a first communication mode supported by the network and the application, wherein the first communication mode is a classic communication mode or a semantic communication mode; and
select the first communication mode to communicate with the network.

2. The apparatus of claim 1, wherein the processing circuitry is further configured to:
process, based on signaling originated by a further UE executing a corresponding application to the application, an indication comprising one or more semantic communication modes supported by the further UE; and
determine the first communication mode is supported by the network, the application and the further UE; and
communicate with the further UE using the first communication mode.

3. The apparatus of claim 2, wherein the further UE comprises a plurality of UEs and the first communication mode is supported by all of the plurality of UEs.

4. The apparatus of claim 2, wherein the UE, the application and the network further support a second communication mode, wherein the further UE comprises a plurality of UEs, a first subset of the plurality of UEs supporting the first and second communication mode and a second subset of the plurality of UEs supporting only the second communication mode, wherein the UE communicates with the first subset using the first communication mode and communicates with the second subset using the second communication mode.

5. The apparatus of claim 1, wherein the message is received as part of a registration procedure performed by the UE with the network, wherein the registration procedure is an initial registration procedure or a mobility registration procedure.

6. The apparatus of claim 1, wherein the message is received in a broadcast message from the network.

7. The apparatus of claim 1, wherein the processing circuitry is further configured to:
generate, for transmission to the network, a registration request comprising the one or more semantic communication modes supported by the application and the UE, wherein the registration request is for an initial registration procedure or a mobility registration procedure.

8. The apparatus of claim 1, wherein the first communication mode comprises a first plurality of communication modes and wherein the processing circuitry is further configured to:
select one of the first plurality of communication modes as the first communication mode based on a further input.

9. The apparatus of claim 8, wherein the further input comprises an indication by the network that only semantic communication modes are to be used, wherein the first communication mode is a semantic communication mode.

10. The apparatus of claim 1, wherein the classic communication mode uses a higher data rate than the semantic communication mode.

11. The apparatus of claim 1, wherein the processing circuitry is further configured to:
start a timer having a predetermined expiration time when the first communication mode is selected, wherein the UE is prevented from switching from the first communication mode until the timer has expired.

12. An apparatus comprising processing circuitry configured to:
execute an application, wherein the application supports a classic communication mode and a semantic communication mode;
communicate with a first network using the classic communication mode, wherein the first network supports the classic communication mode with a first uplink (UL) data rate;
determine a user equipment (UE) has left a coverage area of the first network; and
communicate with a second network using the semantic communication mode, wherein the second network supports the semantic communication mode with a second UL data rate that is lower than the first UL data rate.

13. The apparatus of claim 12, wherein the first network is a terrestrial network and the second network is a non-terrestrial network.

14. An apparatus comprising processing circuitry configured to:
process, based on signaling originated by a user equipment (UE), a request comprising the one or more semantic communication modes supported by an application being executed by the UE and the UE;
generate, for transmission to the UE, a message comprising an indication of one or more semantic communication modes supported by a network; and
process, based on signals originated by the UE, a first communication mode selected by the UE, wherein the first communication mode is a classic communication mode or a semantic communication mode.

15. The apparatus of claim 14, wherein the request is a registration request, wherein the registration request is an initial registration request or a mobility registration request.

16. The apparatus of claim 14, wherein the message is transmitted in a broadcast message, wherein the broadcast message comprises a system information block (SIB) transmitted by a cell of the network.

17. The apparatus of claim 14, wherein the processing circuitry is further configured to:
generate, for transmission to the UE, an indication that only semantic communication modes are to be used by the UE, wherein the first communication mode is a semantic communication mode.

18. The apparatus of claim 14, wherein the processing circuitry is further configured to:
generate, for transmission to the UE, an indication that semantic communication modes are preferred by the network, wherein the indication further comprises a time in which the further input is to be applied, wherein the time comprises upon receipt of the indication or during a specified time window.

19. The apparatus of claim 14, wherein the classic communication mode uses a higher data rate than the semantic communication mode.

20. The apparatus of claim 14, wherein the semantic communication mode comprises a plurality of semantic communication modes and wherein each of the plurality of semantic communication modes uses a different data rate.
